(19) United States
(12) Patent Application Publication
(10) Pub. No.: US 2026/0185606 A1
(43) Pub. Date: Jul. 2, 2026

(54) PLANETARY GEAR DEVICE AND RESIN MOLDED BODY

(71) Applicant: Enplas Corporation, Saitama (JP)

(72) Inventor: Koki HISAI, Saitama (JP)

(73) Assignee: Enplas Corporation, Saitama (JP)

(21) Appl. No.: 19/430,424

(22) Filed: Dec. 23, 2025

(30) Foreign Application Priority Data
Dec. 27, 2024 (JP) 2024-232232

(51) Int. Cl. F16H 57/08; F16H 1/28

(52) U.S. Cl. CPC F16H 57/082; F16H 1/28; F16H 2057/085

(57) ABSTRACT

A planetary gear device includes: a sun gear; an internal gear; a planetary gear that includes a planetary shaft portion, meshes with the sun gear and the internal gear, and revolves around the sun gear while rotating around the planetary shaft portion; and a carrier that includes a bearing portion and rotates around a carrier axis center by pressing force to output rotational motion, the pressing force being transmitted from the planetary shaft portion via the bearing portion during the revolution of the planetary gear. The bearing portion allows displacement of the planetary shaft portion.

### RELATED APPLICATION(S)

This application claims the benefit of priority of Japanese Patent Application No. 2024-232232, filed on December 27, 2024, the disclosure of which including the specification, drawings and abstract is incorporated herein by reference in its entirety.

### TECHNICAL FIELD

The present invention relates to a planetary gear device and a resin molded body.

### BACKGROUND ART

A planetary gear device is used as a reducer that decelerates and outputs input rotation in various mechanical devices such as an automobile and a robot.

In the planetary gear device, a sun gear is connected to a rotary shaft of a drive source such as a motor. Between the sun gear and an internal gear that surrounds the outer periphery of the sun gear and is disposed coaxially with the sun gear, a planetary gear that meshes with both the sun gear and the internal gear is disposed. The planetary gear is supported by a carrier and rotates (also referred to as "spins") around a planetary shaft portion while revolving (also referred to as "orbiting") around the sun gear. The rotational speed (number of rotations per unit time) of the revolution of the planetary gear is a speed that is decelerated at a predetermined ratio (reduction ratio) with respect to the rotational speed of the rotation input from the drive source to the sun gear. The carrier rotates around a carrier axis center as the planetary gear revolves. An output shaft is connected to the carrier at a position on the carrier axis center, and the rotational motion of the carrier is output to the outside via the output shaft.

For example, in the conventional planetary gear device described in PTL 1, in the carrier that supports the planetary gear, an opening of a bearing portion for housing the planetary shaft portion not only penetrates through the carrier body portion in the axial direction, but also is open to the outside in the carrier radial direction. Thus, the opening of the bearing portion has an approximately C-shaped opening shape in an axial plan view. The inner wall of the opening of the bearing portion is configured to be in contact with the outer peripheral surface of the attached planetary shaft portion over a range of more than 180° (in PTL 1, a range of angles α and β, which are each more than 90°). That is, the bearing portion holds the attached planetary shaft portion such that the planetary shaft is not displaced.

### CITATION LIST

### Patent Literature

PTL 1

United States Patent No. 11353105

### SUMMARY OF INVENTION

### Technical Problem

Incidentally, the planetary gear device is used while being connected to an external mechanical device via the output shaft as described above, and it is thus desired to have robustness that is resistant to external influences during operation. Further, from the viewpoint of manufacturing cost, it is desired to have a high degree of freedom, allowing the device to be adapted to various mechanical devices or various installation environments. That is, a planetary gear device with high usability is required.

An object of the present invention is to provide a planetary gear device and a resin molded body with high usability.

### Solution to Problem

An aspect of a planetary gear device according to the present invention includes:

a sun gear;

an internal gear that surrounds an outer periphery of the sun gear and is disposed coaxially with the sun gear;

a planetary gear that includes a planetary shaft portion disposed to protrude, meshes with the sun gear and the internal gear, and revolves around the sun gear while rotating around the planetary shaft portion; and

a carrier that includes a bearing portion rotatably housing the planetary shaft portion, and rotates around a carrier axis center by pressing force to output rotational motion, the pressing force being transmitted from the planetary shaft portion via the bearing portion during the revolution of the planetary gear, in which

the bearing portion allows displacement of the planetary shaft portion.

An aspect of a resin molded body according to the present invention is used as the carrier in the above-described planetary gear device.

### Advantageous Effects of Invention

According to the present invention, the usability of the planetary gear device can be improved.

### BRIEF DESCRIPTION OF DRAWINGS

FIG. 1 is an exploded perspective view of an actuator including a planetary gear device according to an embodiment of the present invention;

FIG. 2 is an exploded perspective view of the planetary gear device according to the present embodiment;

FIG. 3 is an exploded perspective view of a main part of an output-side planetary gear mechanism in the planetary gear device according to the present embodiment;

FIG. 4 is a diagram for describing a relationship between components of the output-side planetary gear mechanism;

FIG. 5 is a front perspective view of an output-side carrier;

FIG. 6 is a rear perspective view of the output-side carrier;

FIG. 7 is a diagram for describing an external influence on the planetary gear device;

FIG. 8 is a diagram for describing a configuration of a bearing portion of the output-side carrier;

FIG. 9 is a diagram for describing details of the bearing portion of the output-side carrier;

FIG. 10 is a diagram for describing a relationship between an output shaft connecting portion of the output-side carrier and an outer cylinder portion of an output-side housing member;

FIG. 11 is a diagram illustrating a phenomenon in which the output shaft is displaced to a positive Y direction;

FIG. 12 is a diagram illustrating a state in which the output shaft connecting portion of the carrier is displaced to the positive Y direction in accordance with the phenomenon illustrated in FIG. 11;

FIGS. 13A to 13D are diagrams for describing a rotation operation of the output-side planetary gear mechanism in the state illustrated in FIG. 12, FIG. 13A is a diagram illustrating an angular position of an output-side movable portion at a first point in time, FIG. 13B is a diagram illustrating a displacement of a specific planetary shaft portion in a specific bearing portion at the first point in time, FIG. 13C is a diagram illustrating an angular position of the output-side movable portion at a second point in time, and FIG. 13D is a diagram illustrating a displacement of the specific planetary shaft portion in the specific bearing portion at the second point in time;

FIG. 14 is a diagram for describing a planetary gear device according to Variation 1, which is a variation related to gear dimensions of the present embodiment;

FIGS. 15A and 15B are diagrams for describing a planetary gear device according to Variation 2, which is a variation related to an opening shape of the bearing portion of the present embodiment, FIG. 15A is a diagram illustrating a state in which the bearing portion houses a planetary shaft portion having a relatively small diameter, and FIG. 15B is a diagram illustrating a state in which the bearing portion houses a planetary shaft portion having a relatively large diameter;

FIGS. 16A and 16B are diagrams for describing a planetary gear device according to Variation 3, which is another variation related to the opening shape of the bearing portion of the present embodiment, FIG. 16A is a diagram illustrating a state in which the bearing portion houses a planetary shaft portion having a relatively small diameter, and FIG. 16B is a diagram illustrating a state in which the bearing portion houses a planetary shaft portion having a relatively large diameter; and

FIG. 17 is a diagram for describing a planetary gear device according to Variation 4, which is still another variation related to the opening shape of the bearing portion of the present embodiment.

### DESCRIPTION OF EMBODIMENTS

Hereinafter, the planetary gear device according to the embodiment of the present invention will be described with reference to the drawings.

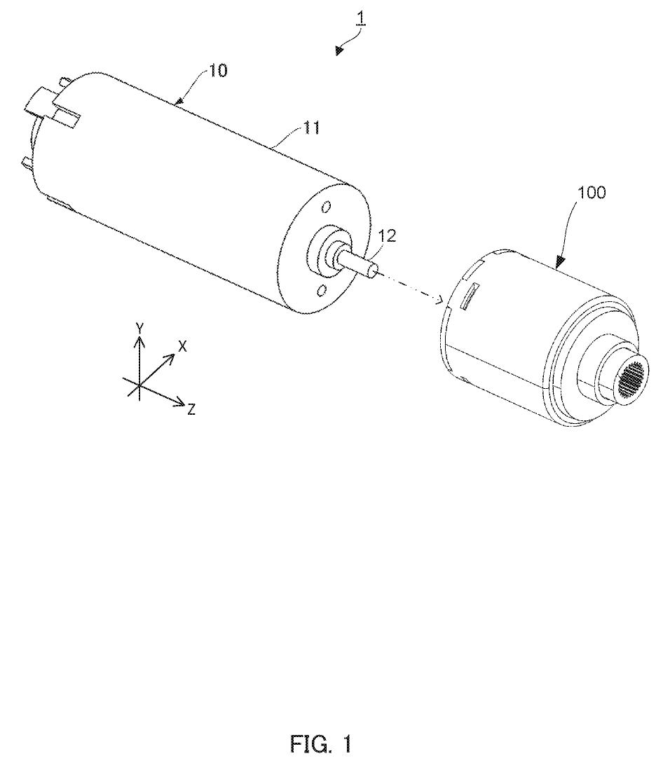

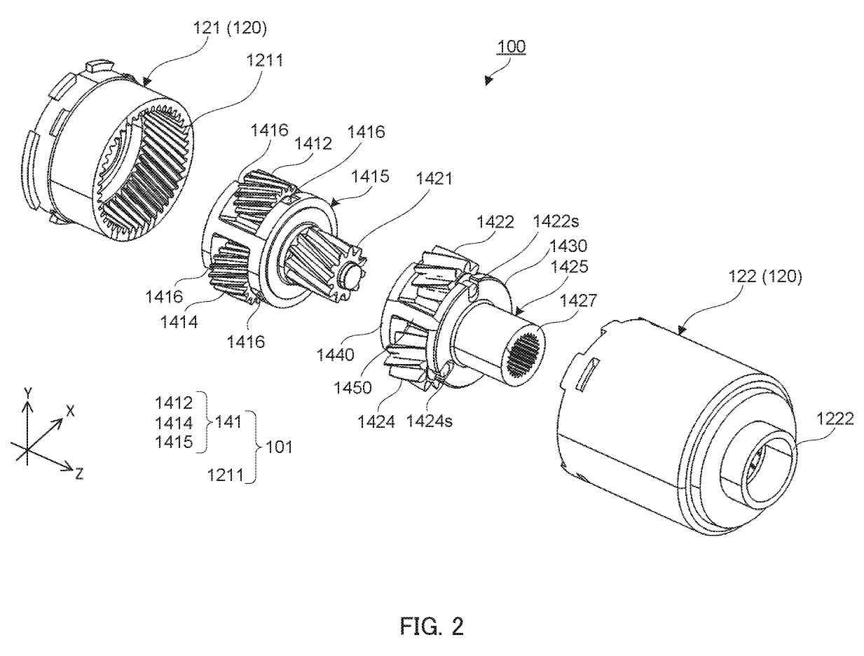

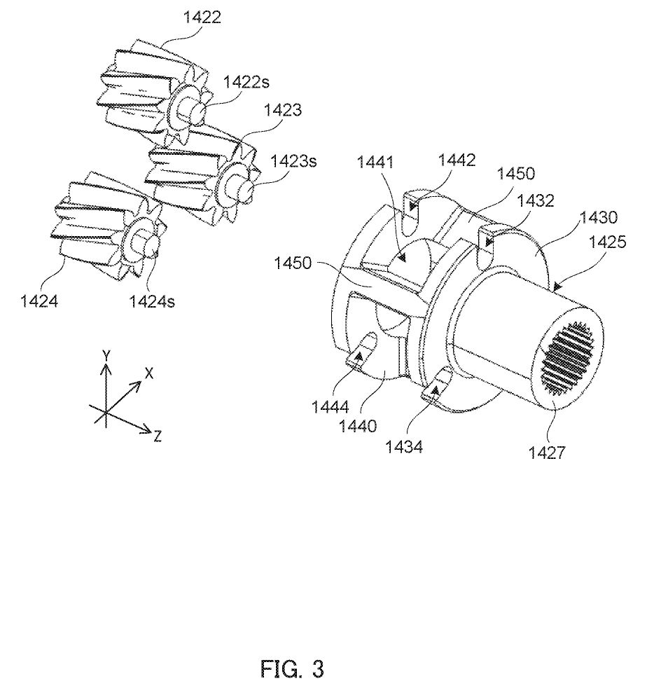

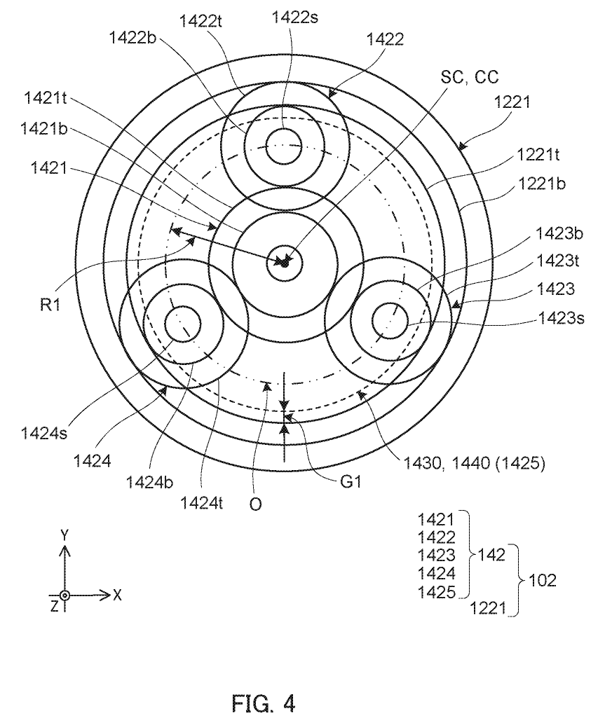

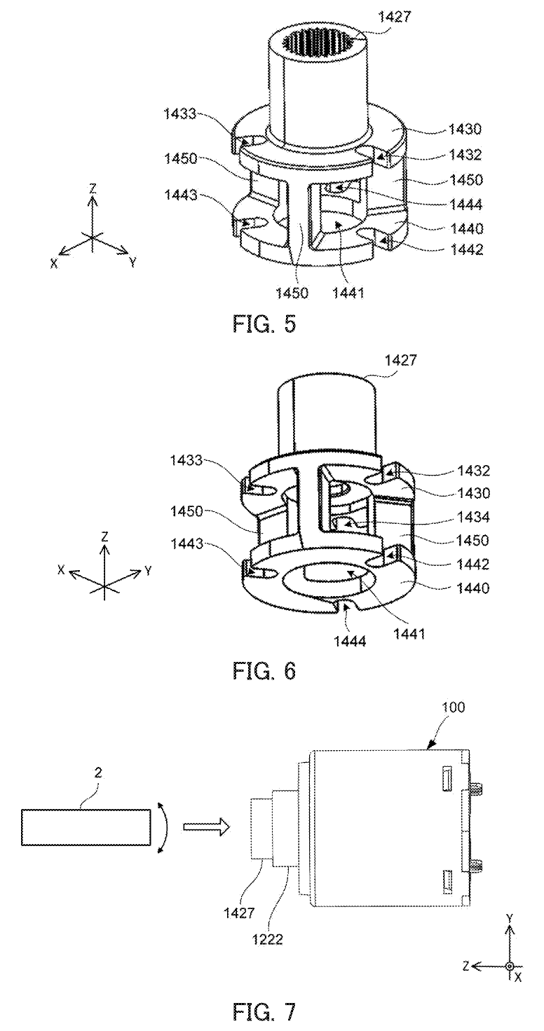

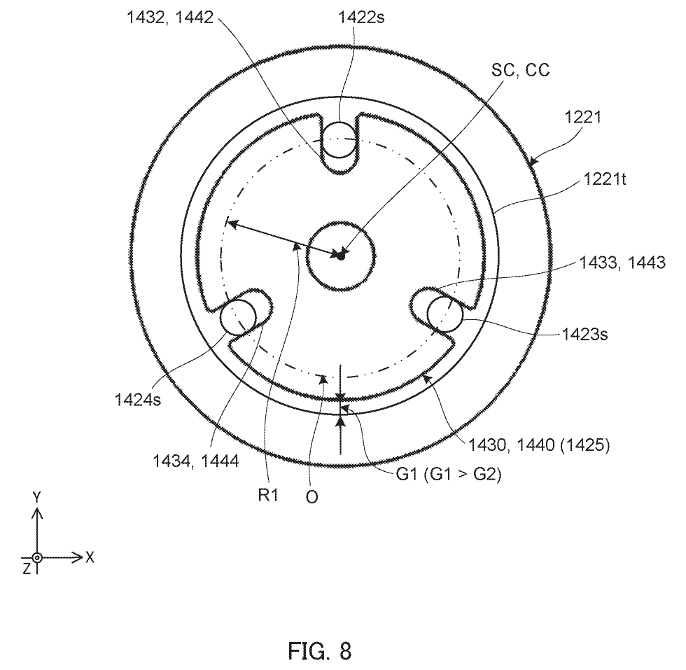

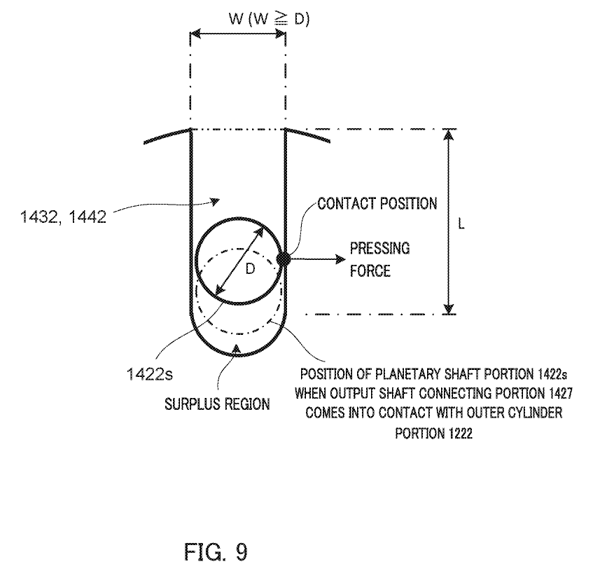

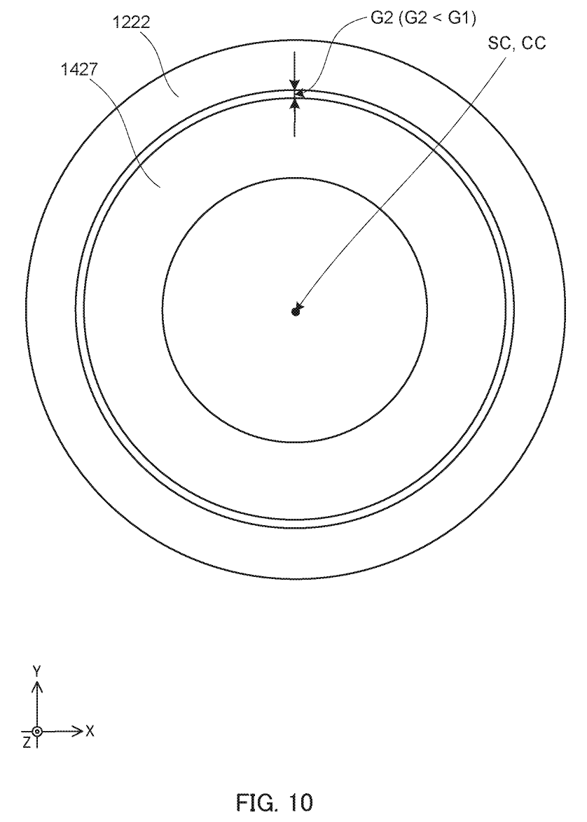

FIG. 1 is an exploded perspective view of an actuator including a planetary gear device according to the present embodiment. FIG. 2 is an exploded perspective view of the planetary gear device according to the present embodiment. FIG. 3 is an exploded perspective view of a main part of an output-side planetary gear mechanism in the planetary gear device according to the present embodiment. FIG. 4 is a diagram for describing a relationship between components of the output-side planetary gear mechanism. FIG. 5 is a front perspective view of an output-side carrier. FIG. 6 is a rear perspective view of the output-side carrier. FIG. 7 is a diagram for describing an external influence on the planetary gear device. FIG. 8 is a diagram for describing a configuration of a bearing portion of the output-side carrier. FIG. 9 is a diagram for describing details of the bearing portion of the output-side carrier. FIG. 10 is a diagram for describing a relationship between an output shaft connecting portion of the output-side carrier and an outer cylinder portion of an output-side housing member.

In the following description, an orthogonal coordinate system (X, Y, Z) is used. The Z direction is a direction parallel to an axial direction of each component constituting planetary gear device 100. For convenience of description, in the Z direction, the + (positive) side is sometimes referred to as a front side or an output side, and the - (negative) side is sometimes referred to as a rear side or an input side. In addition, the X direction is sometimes referred to as a left-right direction, and the Y direction is sometimes referred to as an up-down direction. In addition, a direction radially extending from an axis center of each component is referred to as a radial direction, a side closer to the axis center of each component in the radial direction is referred to as an inner side, and a side farther from the axis center of each component in the radial direction is referred to as an outer side. In addition, a direction in which each component extends in an annular shape around the axis center of each component is referred to as a circumferential direction. Note that, when referring to a term such as the axial direction, the axis center, the radial direction, or the circumferential direction for a specific component, the name of the component is combined with the term. For example, when referring to the axial direction, the axis center, the radial direction, or the circumferential direction of the carrier, the term "carrier axial direction," "carrier axis center," "carrier radial direction," or "carrier circumferential direction" is used. When referring to a direction in which each component rotates, the term "rotation direction" is used in combination with the name of each component (for example, "carrier rotation direction"). Hereinafter, in the rotation direction, a clockwise direction means that the rotation as viewed from the positive Z direction is clockwise (right rotation), and a counterclockwise direction means that the rotation as viewed from the positive Z direction is counterclockwise (left rotation).

In the present embodiment, actuator 1 includes: motor 10 that is an example of a drive source; and planetary gear device 100. Actuator 1 is used as, for example, an actuator of an electric back door for an automobile that is used for opening and closing a back door of an automobile. However, the application of actuator 1 is not limited thereto. Motor 10 includes motor body 11 and rotary shaft 12. Motor 10 operates under the control of a control portion (not illustrated) to rotate rotary shaft 12 and drive planetary gear device 100. The type of motor 10 is not particularly limited, and various electric motors conventionally known may be used.

Planetary gear device 100 decelerates the rotation input from motor 10 at a predetermined reduction ratio and outputs the decelerated rotation externally. Planetary gear device 100 includes housing 120 and movable portion 140 housed in housing 120. Housing 120 includes input-side housing member 121 and output-side housing member 122. Movable portion 140 includes input-side movable portion 141 and output-side movable portion 142. Input-side movable portion 141 constitutes input-side planetary gear mechanism 101 together with internal gear (input-side internal gear) 1211 of input-side housing member 121. Output-side movable portion 142 constitutes output-side planetary gear mechanism 102 together with internal gear (output-side internal gear) 1221 of output-side housing member 122.

Each of the components constituting planetary gear device 100 may be, for example, a resin molded body obtained by processing a resin material by a method such as injection molding, but a resin component may be used for only a part, and a metal component may be used for the rest. However, when a component having a complicated structure, such as input-side carrier 1415 or output-side carrier 1425 described below, is integrally molded using a resin material, it is advantageous in that the manufacturing cost of planetary gear device 100 can be significantly reduced.

Input-side movable portion 141 and output-side movable portion 142 are disposed on the input side and the output side, respectively, along the Z direction, and are housed in housing 120 closed by input-side housing member 121 and output-side housing member 122. Input-side planetary gear mechanism 101 decelerates the rotation input from motor 10 at a predetermined reduction ratio and outputs the decelerated rotation to output-side planetary gear mechanism 102 at a subsequent stage. Output-side planetary gear mechanism 102 decelerates the rotation input from input-side planetary gear mechanism 101 at a predetermined reduction ratio and outputs the decelerated rotation externally.

Note that, in the present embodiment, planetary gear device 100 includes two stages of planetary gear mechanisms (input-side planetary gear mechanism 101 and output-side planetary gear mechanism 102), but the number of stages of the planetary gear mechanism is not limited to two. The number of stages of the planetary gear mechanism may be only one or three or more.

Input-side movable portion 141 includes an input-side sun gear (not illustrated), three input-side planetary gears 1412 and 1414 (one of them is not illustrated), and input-side carrier 1415. The input-side sun gear is connected to rotary shaft 12 of motor 10 and rotates around the same axis center as rotary shaft 12. That is, the input-side sun gear is directly driven and rotated by motor 10. The sun gear toothed portion formed on the outer peripheral surface of the input-side sun gear is, for example, a so-called helical gear having spiral teeth that is obliquely cut with respect to the axial direction of the input-side sun gear. Three input-side planetary gears 1412 and 1414 are disposed at substantially equal gaps in the circumferential direction of the input-side sun gear. Three input-side planetary gears 1412 and 1414 mesh with both the input-side sun gear and input-side internal gear 1211 disposed coaxially with the input-side sun gear. The toothed portions formed on the outer peripheral surfaces of three input-side planetary gears 1412 and 1414 and the toothed portion formed on the inner peripheral surface of input-side internal gear 1211 are, for example, so-called helical gears having spiral teeth that are obliquely cut with respect to the axial direction. Three input-side planetary gears 1412 and 1414 are each supported so as to be capable of rotating on its own axis, by bearing portion 1416 formed in input-side carrier 1415. Based on the rotation of the input-side sun gear, three input-side planetary gears 1412 and 1414 revolve (orbit) around the input-side sun gear while rotating (spinning) around their axis centers (planetary shaft portions). Input-side carrier 1415 rotates around the axis center of input-side carrier 1415 based on the orbiting of three input-side planetary gears 1412 and 1414. Input-side carrier 1415 outputs the rotational motion to sun gear (output-side sun gear) 1421 of output-side movable portion 142 connected to the output-side end portion of input-side carrier 1415.

Note that, in the present embodiment, the opening shape of bearing portion 1416 formed in input-side carrier 1415 is the same as the opening shape of a bearing portion (first bearing portions 1432, 1433, and 1434, and second bearing portions 1442, 1443, and 1444) formed in output-side carrier 1425 described below. Details of the opening shape of the bearing portion will be described later. However, various configurations conventionally known may be adopted for the configuration of input-side planetary gear mechanism 101 including input-side carrier 1415.

Output-side movable portion 142 includes output-side sun gear 1421, three output-side planetary gears 1422, 1423, and 1424, and output-side carrier 1425. As described above, output-side sun gear 1421 is connected to the output-side end portion of input-side carrier 1415 and rotates about the same axis center as input-side carrier 1415. That is, output-side sun gear 1421 is driven and rotated by input-side carrier 1415, but can also be considered to be indirectly driven and rotated by motor 10. As a variation, output-side sun gear 1421 may be directly connected to rotary shaft 12 of motor 10, and in this case, output-side sun gear 1421 is directly driven and rotated by motor 10.

The sun gear toothed portion formed on the outer peripheral surface of output-side sun gear 1421 is, for example, a so-called helical gear having spiral teeth obliquely cut with respect to the axial direction of output-side sun gear 1421. The toothed portions formed on the outer peripheral surfaces of three output-side planetary gears 1422, 1423, and 1424 and the toothed portion formed on the inner peripheral surface of output-side internal gear 1221 are, for example, so-called helical gears having spiral teeth obliquely cut with respect to their respective axial directions.

Three output-side planetary gears 1422, 1423, and 1424 are disposed at substantially equal gaps in the output-side sun gear circumferential direction. Three output-side planetary gears 1422, 1423, and 1424 mesh with both output-side sun gear 1421 and output-side internal gear 1221 disposed coaxially with output-side sun gear 1421 (see FIG. 4).

Note that FIG. 4 schematically illustrates meshing between the toothed portions. In FIG. 4, circle 1421b indicates a tooth root of output-side sun gear 1421, and circle 1421t indicates a tooth tip of output-side sun gear 1421. In addition, circle 1422b indicates a tooth root of output-side planetary gear 1422, and circle 1422t indicates a tooth tip of output-side planetary gear 1422. Similarly, circles 1423b and 1424b indicate tooth roots of output-side planetary gears 1423 and 1424, and circles 1423t and 1424t indicate tooth tips of output-side planetary gears 1423 and 1424. As illustrated in FIG. 4, a center distance between output-side sun gear 1421 and output-side planetary gears 1422, 1423, and 1424 in a meshing state with output-side internal gear 1221 is radius (revolution radius) R1 of revolution orbit O of output-side planetary gears 1422, 1423, and 1424. In addition, as illustrated in FIG. 4, gap G1 is provided as a clearance between the outer peripheries of first annular plate-shaped portion 1430 and second annular plate-shaped portion 1440 of output-side carrier 1425 and the inner periphery (circle 1221t) of output-side internal gear 1221.

Planetary shaft portion 1422s is rotatably housed in first bearing portion 1432 and second bearing portion 1442 formed in first annular plate-shaped portion 1430 and second annular plate-shaped portion 1440, respectively, so that output-side planetary gear 1422 is supported so as to be capable of rotating on its own axis. Planetary shaft portion 1423s is rotatably housed in first bearing portion 1433 and second bearing portion 1443 formed in first annular plate-shaped portion 1430 and second annular plate-shaped portion 1440, respectively, so that output-side planetary gear 1423 is supported so as to be capable of rotating on its own axis. Planetary shaft portion 1424s is rotatably housed in first bearing portion 1434 and second bearing portion 1444 formed in first annular plate-shaped portion 1430 and second annular plate-shaped portion 1440, respectively, so that output-side planetary gear 1424 is supported so as to be capable of rotating on its own axis.

Based on the rotation of output-side sun gear 1421, output-side planetary gears 1422, 1423, and 1424 revolve (orbit) around output-side sun gear 1421 while rotating (spinning) around the axis centers of output-side planetary gears 1422, 1423, and 1424, respectively, that is, around planetary shaft portions 1422s, 1423s, and 1424s disposed in output-side planetary gears 1422, 1423, and 1424 to protrude. Output-side carrier 1425 rotates around the axis center of output-side carrier 1425 based on the orbiting of output-side planetary gears 1422, 1423, and 1424. Output-side carrier 1425 outputs rotational motion to the outside via output shaft 2 connected to output shaft connecting portion 1427 disposed at an output-side end portion of output-side carrier 1425. Note that, in the present embodiment, output shaft connecting portion 1427 is a cylindrical portion having a knurled tooth portion on the inner peripheral surface, and output shaft 2 having a tooth portion in a corresponding shape on the outer peripheral surface of the rear end portion is inserted into output shaft connecting portion 1427. Output shaft connecting portion 1427 is an example of a rotational motion output portion.

Output-side carrier 1425 includes first annular plate-shaped portion 1430 and second annular plate-shaped portion 1440 that are annular plate-shaped bodies spaced apart in the Z direction. First annular plate-shaped portion 1430 and second annular plate-shaped portion 1440 are connected to each other in a state of being parallel to each other, by radial columnar portion 1450 that extends radially in the XY plane and extends in a columnar manner in the Z direction. Through-hole 1441 into which output-side sun gear 1421 is inserted is provided in second annular plate-shaped portion 1440, and output shaft connecting portion 1427 is provided on an output-side end surface of first annular plate-shaped portion 1430. When each of output-side planetary gears 1422, 1423, and 1424 is attached to output-side carrier 1425, first annular plate-shaped portion 1430 and second annular plate-shaped portion 1440 are disposed on both sides of each of output-side planetary gears 1422, 1423, and 1424 in the Z direction.

First annular plate-shaped portion 1430 and second annular plate-shaped portion 1440 each have bearing portions equal in number to output-side planetary gears 1422, 1423, and 1424 at substantially equal spaced angular positions. The bearing portions provided in first annular plate-shaped portion 1430 are first bearing portions 1432, 1433, and 1434. The bearing portions provided in second annular plate-shaped portion 1440 are second bearing portions 1442, 1443, and 1444. First bearing portions 1432, 1433, and 1434 and second bearing portions 1442, 1443, and 1444, which are located at the same angular positions, respectively have the same opening shape as each other. Specifically, in the present embodiment, the openings of first bearing portions 1432, 1433, and 1434 and second bearing portions 1442, 1443, and 1444 not only penetrate first bearing portions 1432, 1433, and 1434 and second bearing portions 1442, 1443, and 1444 in the axial direction, respectively, but also opened to the outer side in the radial direction of the output-side carrier (hereinafter, simply referred to as "carrier radial direction"). Thus, the openings each have an approximately C-shaped opening shape in the axial plan view. Therefore, output-side planetary gears 1422, 1423, and 1424 can be easily attached from the outside in the carrier radial direction, and can also be easily removed.

Incidentally, the planetary gear device is generally connected to an external component or device via output shaft 2, and thus there is a problem in that the planetary gear device is easily affected by external influences via output shaft 2 (see FIG. 7). In particular, when force in the up-down direction or the left-right direction is applied to output shaft 2 from the external component or device during the operation of planetary gear device 100, shaft runout (displacement of the axis center) of output shaft 2 occurs, and the shaft runout is transmitted to planetary gear device 100, and an abnormal sound is likely to be generated from planetary gear device 100.

In the present embodiment, first bearing portions 1432, 1433, and 1434 and second bearing portions 1442, 1443, and 1444 are configured such that planetary shaft portions 1422s, 1423s, and 1424s can be displaced, and thus even when the shaft runout of output shaft 2 occurs during the operation, the generation of the abnormal sound can be suppressed.

Specifically, as illustrated in FIGS. 8 and 9, the openings of first bearing portions 1432 and second bearing portions 1442 have extended shapes extending in the carrier radial direction, and due to these shapes, planetary shaft portion 1422s can be displaced in the carrier radial direction in first bearing portions 1432 and second bearing portions 1442. In the present embodiment, because first bearing portions 1432 and second bearing portions 1442 each have a continuous wide shape in which width W equal to or greater than the diameter of planetary shaft portion 1422s continues over substantially the entire length in the carrier radial direction, the movable range of planetary shaft portion 1422s can be secured over substantially the entire length in the carrier radial directions of first bearing portion 1432 and second bearing portion 1442. It should be noted that it is preferred to widely secure the movable range of planetary shaft portion 1422s so that planetary shaft portion 1422s can be displaced over a wide range, but the secured movable range does not necessarily need to be wide. The extended shapes of the openings of first bearing portion 1432 and second bearing portion 1442 may be designed according to the allowable degree of the shaft runout. Note that the above-described conventional bearing portion contacts half the outer circumference or more of the attached planetary shaft portion to grip the planetary gear, and thus the planetary shaft portion cannot be displaced at all. However, the displacement of the planetary shaft portion within the bearing portion is allowed to a small extent when a play due to a manufacturing tolerance is present between the bearing portion and the planetary gear. The abnormal sound caused by the shaft runout cannot be suppressed with such a small displacement. In the present embodiment, the openings of first bearing portion 1432 and second bearing portion 1442 are formed in a continuous wide shape having length L that clearly exceeds the play due to manufacturing tolerance, in order to suppress the abnormal sound caused by the shaft runout.

The above-described extended shape may be any shape as long as the shape has width W and length L in which planetary shaft portion 1422s can move in the carrier radial direction. Thus, the shape is not necessarily a linear band shape as in the present embodiment, and the shape does not need to be an oval shape or an elliptical shape, either. Even in the case where the extended shape is a perfect circle shape, it is possible for planetary shaft portion 1422s to have width W and length L in which planetary shaft portion 1422s can move in the carrier radial direction.

In addition, the carrier radial direction in which planetary shaft portion 1422s is displaceable does not necessarily mean a carrier radial direction in a strict sense passing through output-side carrier axis center CC. Even the displacement that moves in an oblique direction with respect to such a strict carrier radial direction may be regarded as the displacement in the carrier radial direction as long as the displacement causes a change in the separation distance from output-side carrier axis center CC.

During the operation, planetary shaft portion 1422s rotates on its own axis while meshing with output-side sun gear 1421 and output-side internal gear 1221, and moves clockwise in the present embodiment. At this time, planetary shaft portion 1422s comes into contact with the inner walls of first bearing portion 1432 and second bearing portion 1442 to apply pressing force to the inner walls. In this way, the pressing force transmitted from planetary shaft portion 1422s via first bearing portion 1432 and second bearing portion 1442 causes output-side carrier 1425 to rotate around output-side carrier axis center CC and to output the rotational motion. As illustrated in FIG. 9, planetary shaft portion 1422s is displaceable over a range of length L at maximum in first bearing portion 1432 and second bearing portion 1442, and thus the contact position of planetary shaft portion 1422s at which the pressing force is transmitted to first bearing portion 1432 and second bearing portion 1442 is also displaceable over a range of length L at maximum.

Here, it is desired that gap G1 illustrated in FIG. 8 be greater than gap G2 (see FIG. 10) provided as a clearance between the outer periphery of output shaft connecting portion 1427 and outer cylinder portion 1222 (an example of cylindrical portion) surrounding output shaft connecting portion 1427. When gap G1 is less than gap G2, first annular plate-shaped portion 1430 of output-side carrier 1425 is likely to collide with the inner periphery of output-side internal gear 1221. That is, by making gap G1 greater than gap G2, collision of first annular plate-shaped portion 1430 against the inner periphery of output-side internal gear 1221 can be made less likely to occur.

When gap G2 is greater than gap G1, output shaft connecting portion 1427 comes into contact with the inner periphery of outer cylinder portion 1222 before first annular plate-shaped portion 1430 comes into contact with the inner periphery of output-side internal gear 1221. In this case, it is preferred that a surplus region in which planetary shaft portion 1422s is displaceable inward in the carrier radial direction beyond the position of planetary shaft portion 1422s in first bearing portion 1432 and second bearing portion 1442 remain. When first bearing portion 1432 and second bearing portion 1442 each have the extended shape including such a surplus region, the behavior of first bearing portion 1432 and second bearing portion 1442 to push planetary shaft portion 1422s from the inside to the outside does not occur even when the relatively large shaft runout occurs in output-side carrier 1425. Therefore, output-side planetary gear 1422 does not stop operating by being pressed against output-side internal gear 1221.

The contents described with reference to FIGS. 8 and 9 refer to only planetary shaft portion 1422s of output-side planetary gear 1422, and first bearing portion 1432 and second bearing portion 1442 that house planetary shaft portion 1422s. However, output-side planetary gears 1423 and 1424 have shapes with the same dimensions as output-side planetary gear 1422, and first bearing portion 1433 and second bearing portion 1443 and first bearing portion 1434 and second bearing portion 1444 also have shapes with the same dimensions as first bearing portion 1432 and second bearing portion 1442. Therefore, the contents described with reference to FIGS. 8 and 9 also apply to a relationship between planetary shaft portion 1423s of output-side planetary gear 1423, and first bearing portion 1433 and second bearing portion 1443, and a relationship between planetary shaft portion 1424s of output-side planetary gear 1424, and first bearing portion 1434 and second bearing portion 1444.

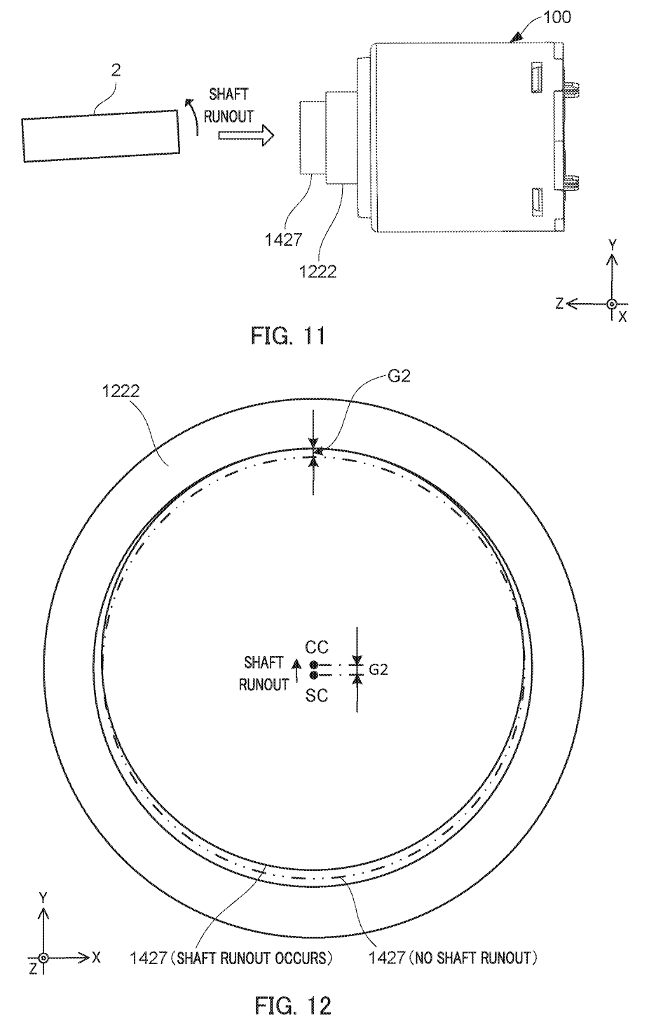

In the following, the rotation operation of output-side planetary gear mechanism 102 during the occurrence of the shaft runout phenomenon in which output shaft 2 is displaced to the positive Y direction will be described. FIG. 11 is a diagram illustrating the shaft runout phenomenon in which output shaft 2 is displaced to the positive Y direction. When output shaft 2 is displaced to the positive Y direction, output shaft connecting portion 1427 is displaced to the positive Y direction accordingly, and the position of output-side carrier axis center CC deviates from the position of output-side sun gear axis center SC by a distance equal to gap G2 to the side of the positive Y direction (see FIG. 12).

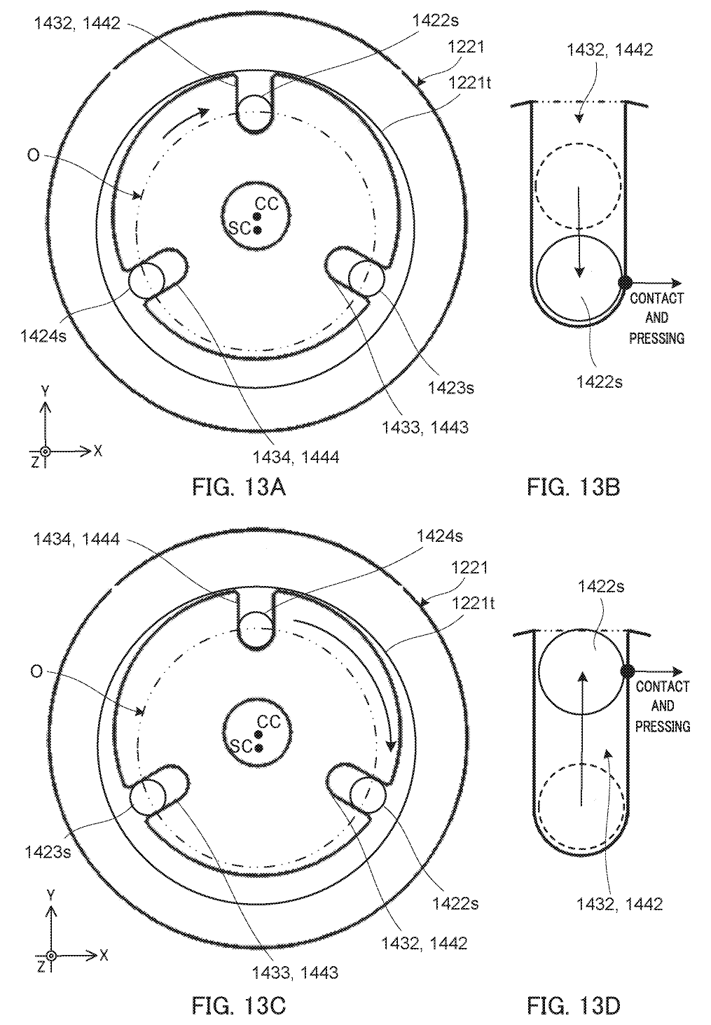

At this time, output-side carrier 1425 as a whole is displaced to the side of the positive Y direction, and first bearing portions 1432, 1433, and 1434 and second bearing portions 1442, 1443, and 1444 are also displaced to the side of the positive Y direction at all angular positions around output-side carrier axis center CC. Even in this state, planetary shaft portions 1422s, 1423s, and 1424s can be displaced in the carrier radial direction in first bearing portions 1432, 1433, and 1434 and second bearing portions 1442, 1443, and 1444. Then, planetary shaft portions 1422s, 1423s, and 1424s can maintain predetermined revolution orbit O while varying the contact positions of planetary shaft portions 1422s, 1423s, and 1424s at which the pressing force is transmitted to first bearing portions 1432, 1433, and 1434 and second bearing portions 1442, 1443, and 1444. For example, in a first point in time (see FIG. 13) at which planetary shaft portion 1422s is at the position on the side of the positive Y direction, planetary shaft portion 1422s moves relatively to the inside in the carrier radial direction by the amount of the displacement of first bearing portion 1432 and second bearing portion 1442 to the side of the positive Y direction (see FIG. 13B). Then, in a second point in time (see FIG. 13C) at which planetary shaft portion 1422s rotates by approximately 120° in the clockwise direction from the first point in time, planetary shaft portion 1422s moves relatively to the outside in the carrier radial direction. As described above, even when the position of planetary shaft portion 1422s, and consequently the contact positions with first bearing portion 1432 and second bearing portion 1442 vary with the rotation operation, revolution orbit O of planetary shaft portion 1422s is maintained, and thus output-side planetary gear mechanism 102 can continue the operation while allowing the shaft runout of output shaft 2. During the operation, an excessive load is also unlikely to be applied between the components of output-side planetary gear mechanism 102, thereby also suppressing generation of abnormal sounds.

In the following, variations of the present embodiment will be described.

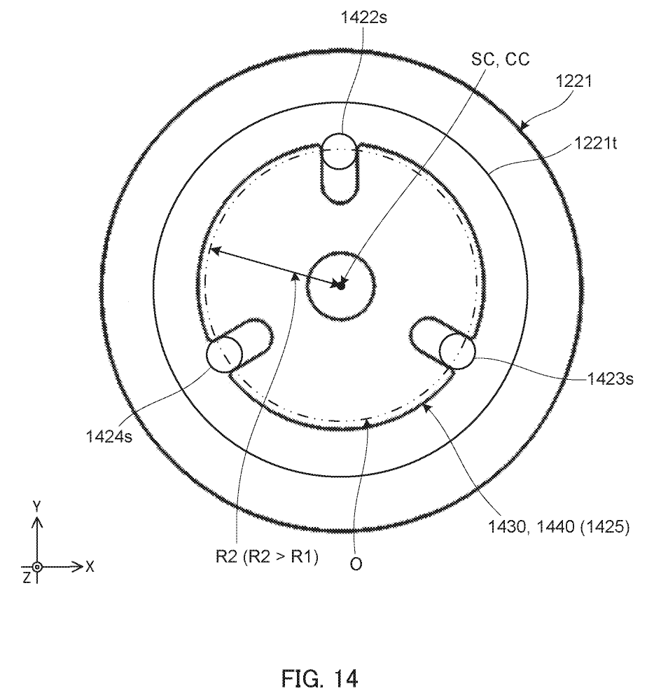

Variation 1 illustrated in FIG. 14 is a variation related to the gear dimensions. In Variation 1 illustrated in FIG. 14, for example, a sun gear having a larger diameter than output-side sun gear 1421 is used. Accordingly, the center distance of output-side planetary gear mechanism 102, that is, the spacing distances (revolution radius R2) of planetary shaft portions 1422s, 1423s, and 1424s from output-side sun gear axis center SC and output-side carrier axis center CC are enlarged as compared with the above-described embodiment (R2 > R1). Nevertheless, output-side carrier 1425 can rotatably house planetary shaft portions 1422s, 1423s, and 1424s at relatively outer positions in first bearing portions 1432, 1433, and 1434 and second bearing portions 1442, 1443, and 1444. Therefore, output-side carrier 1425 can accommodate various center distances, and thus the design flexibility of the planetary gear device can be improved. It goes without saying that when the center distance (revolution radius) of output-side planetary gear mechanism 102 is enlarged and the dimensions of output-side planetary gears 1422, 1423, and 1424 are not changed, the inner diameter of output-side internal gear 1221 needs to be enlarged.

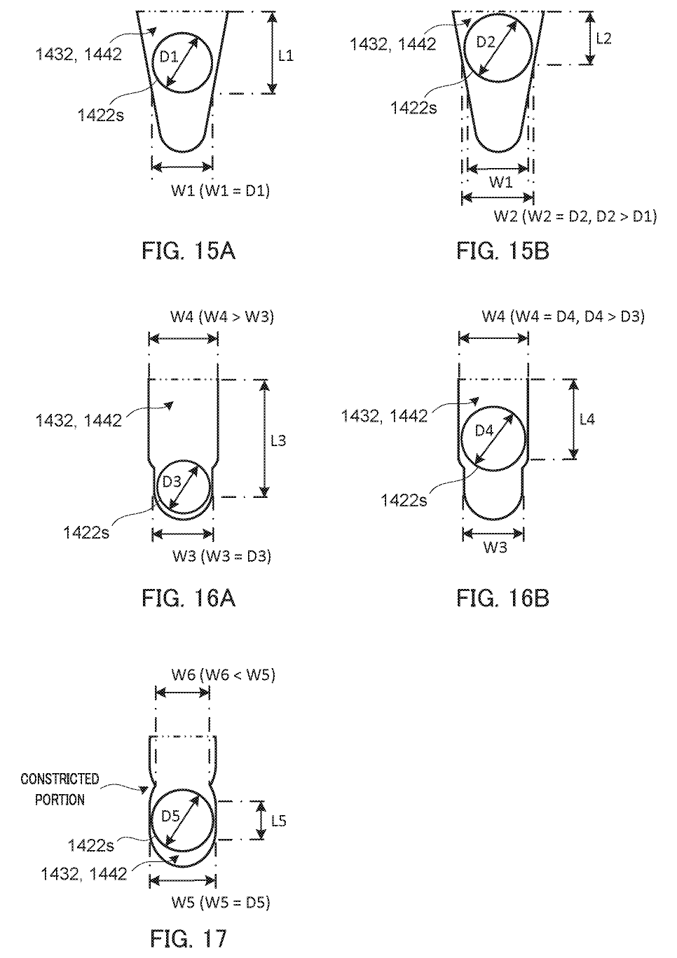

Variation 2 illustrated in FIGS. 15A and 15B is a variation related to the opening shape of the bearing portion (first bearing portion 1432 and second bearing portion 1442 as representatives). In this variation, first bearing portion 1432 and second bearing portion 1442 each have an opening shape in which the width linearly expands from the inside toward the outside in the carrier radial direction. In other words, first bearing portion 1432 and second bearing portion 1442 each have an opening shape in which the width linearly decreases from the outside toward the inside in the carrier radial direction. In the case of such an opening shape, the length of the movable range of planetary shaft portion 1422s can be adjusted while ensuring the movable range of planetary shaft portion 1422s by changing the diameter of planetary shaft portion 1422s. For example, planetary shaft portion 1422s having diameter D1 can be displaced to a position of width W1 (= diameter D1), but when planetary shaft portion 1422s having diameter D2 (> diameter D1) is used, planetary shaft portion 1422s can be displaced only to a position of width W2 (= diameter D2), thereby shortening the movable range from length L1 to length L2. Such an adjustment is effective in ensuring the ease of insertion of output-side sun gear 1421.

Variation 3 illustrated in FIGS. 16A and 16B is a variation related to the opening shape of the bearing portion (first bearing portion 1432 and second bearing portion 1442 as representatives) as in Variation 2. In this variation, first bearing portion 1432 and second bearing portion 1442 each have an opening shape in which the width stepwise expands from the inside toward the outside in the carrier radial direction. In other words, first bearing portion 1432 and second bearing portion 1442 each have an opening shape in which the width stepwise decreases from the outside toward the inside in the carrier radial direction. In the case of such an opening shape as well, the length of the movable range of planetary shaft portion 1422s can be adjusted while ensuring the movable range of planetary shaft portion 1422s by changing the diameter of planetary shaft portion 1422s. For example, planetary shaft portion 1422s having diameter D3 can be displaced to a position of width W3 (= diameter D3), but when planetary shaft portion 1422s having diameter D4 (> diameter D3) is used, planetary shaft portion 1422s can be displaced only to a position of width W4 (= diameter D4), thereby shortening the movable range from length L3 to length L4.

Variation 4 illustrated in FIG. 17 is a variation related to the opening shape of the bearing portion (first bearing portion 1432 and second bearing portion 1442 as representatives) as in Variations 2 and 3. As illustrated in this variation, to prevent removal of planetary shaft portion 1422s from first bearing portion 1432 and second bearing portion 1442, the opening shape may be locally constricted. In this case, when diameter D5 of planetary shaft portion 1422s is greater than width W6 of the constricted portion and is equal to width W5 (> width W6), length L5 of the movable range can be ensured.

As described above, according to the present embodiment, planetary gear device 100 includes output-side sun gear 1421, output-side internal gear 1221, output-side planetary gears 1422, 1423, and 1424, and output-side carrier 1425. Output-side internal gear 1221 surrounds the outer periphery of output-side sun gear 1421 and is disposed coaxially with output-side sun gear 1421. Output-side planetary gears 1422, 1423, and 1424 respectively include planetary shaft portions 1422s, 1423s, and 1424s disposed to protrude, mesh with output-side sun gear 1421 and output-side internal gear 1221, and revolve around output-side sun gear 1421 while rotating around planetary shaft portions 1422s, 1423s, and 1424s. Output-side carrier 1425 includes first bearing portions 1432, 1433, and 1434 and second bearing portions 1442, 1443, and 1444 that rotatably house planetary shaft portions 1422s, 1423s, and 1424s, respectively. Output-side carrier 1425 rotates around output-side carrier axis center CC by the pressing force transmitted from planetary shaft portions 1422s, 1423s, and 1424s via first bearing portions 1432, 1433, and 1434 and second bearing portions 1442, 1443, and 1444 during the revolving of output-side planetary gears 1422, 1423, and 1424, and outputs the rotational motion. First bearing portions 1432, 1433, and 1434 and second bearing portions 1442, 1443, and 1444 allow the displacement of planetary shaft portions 1422s, 1423s, and 1424s, respectively, in the carrier radial direction particularly. As a result, planetary gear device 100 can continue the operation while allowing the shaft runout of output shaft 2, and since an excessive load is also unlikely to be applied between the components of planetary gear device 100 during the operation, the generation of the abnormal sound can also be suppressed. That is, planetary gear device 100 can have robustness that is resistant to external influences during operation.

Although the embodiment of the present invention has been described in detail above, the present invention is not limited to the specific embodiment described above. Various modifications and changes can be made to the specific examples described in the embodiment within the gist of the present invention described in the claims.

### Industrial Applicability

The planetary gear device according to the present invention is useful as a planetary gear device used in various actuators such as an actuator for opening and closing a back door.

### REFERENCE SIGNS LIST

1 Actuator

2 Output shaft

10 Motor

11 Motor body

12 Rotary shaft

100 Planetary gear device

101 Input-side planetary gear mechanism

102 Output-side planetary gear mechanism

120 Housing

121 Input-side housing member

1211 Input-side internal gear

122 Output-side housing member

1221 Output-side internal gear

1222 Outer cylinder portion

140 Movable portion

141 Input-side movable portion

1412, 1414 Input-side planetary gear

1415 Input-side carrier

1416 Bearing portion

142 Output-side movable portion

1421 Output-side sun gear

1422, 1423, 1424 Output-side planetary gear

1422s, 1423s, 1424s Planetary shaft portion

1425 Output-side carrier

1427 Output shaft connecting portion

1430 First annular plate-shaped portion

1432, 1433, 1434 First bearing portion

1440 Second annular plate-shaped portion

1442, 1443, 1444 Second bearing portion

1441 Through-hole

1450 Radial columnar portion

CC Output-side carrier axis center

G1, G2 Gap

O Revolution orbit

R1, R2 Revolution radius (center distance)

SC Output-side sun gear axis center

W, W1, W2, W3, W4, W5, W6 Width

D, D1, D2, D3, D4, D5 Shaft diameter

L, L1, L2, L3, L4, L5 Length

What is claimed is:

1. A planetary gear device, comprising:
a sun gear;
an internal gear that surrounds an outer periphery of the sun gear and is disposed coaxially with the sun gear;
a planetary gear that includes a planetary shaft portion disposed to protrude, meshes with the sun gear and the internal gear, and revolves around the sun gear while rotating around the planetary shaft portion; and
a carrier that includes a bearing portion rotatably housing the planetary shaft portion, and rotates around a carrier axis center by pressing force to output rotational motion, the pressing force being transmitted from the planetary shaft portion via the bearing portion during the revolution of the planetary gear, wherein
the bearing portion allows displacement of the planetary shaft portion.

2. The planetary gear device according to claim 1, wherein
the bearing portion allows, in a carrier radial direction, displacement of a contact position of the planetary shaft portion at which the pressing force is transmitted.

3. The planetary gear device according to claim 1, wherein
the bearing portion allows the displacement of the planetary shaft portion in accordance with displacement of the carrier axis center with respect to an axis center of the sun gear.

4. The planetary gear device according to claim 3, wherein
the bearing portion varies, in a carrier radial direction, a contact position of the planetary shaft portion at which the pressing force is transmitted, when the planetary gear revolves while the carrier axis center is displaced with respect to the axis center of the sun gear.

5. The planetary gear device according to claim 1, wherein
the bearing portion includes an opening having a shape extending in a carrier radial direction to allow the displacement of the planetary shaft portion inside the opening in the carrier radial direction.

6. The planetary gear device according to claim 5, wherein
the bearing portion includes a first bearing portion and a second bearing portion disposed on both sides of the planetary gear in a carrier axial direction, and
the first bearing portion and the second bearing portion each have the shape identical to each other.

7. The planetary gear device according to claim 5, wherein
the shape has a width equal to or greater than a diameter of the planetary shaft portion, the width being continuous in the carrier radial direction.

8. The planetary gear device according to claim 7, wherein
the width of the shape is narrowed from an outer side toward an inner side in the carrier radial direction.

9. The planetary gear device according to claim 7, further comprising a housing that includes a cylindrical portion surrounding a rotational motion output portion with a clearance in the carrier radial direction, the rotational motion output portion defining the carrier axis center, wherein
the shape includes a surplus region in which the planetary shaft portion is displaceable inward beyond a position of the planetary shaft portion when the rotational motion output portion comes into contact with the cylindrical portion.

10. A resin molded body that is used as the carrier in the planetary gear device according to claim 1.
